(19) United States
(12) Patent Application Publication
(10) Pub. No.: US 2013/0200285 A1
(43) Pub. Date: Aug. 8, 2013

(54) MULTI-TEETH ENGAGEMENT IN AN ACTUATOR PISTON

(71) Applicants: David Gent, Houston, TX (US); John Dernovsek, Wiarton (CA); Darin Carlson, Cypress, TX (US)

(72) Inventors: David Gent, Houston, TX (US); John Dernovsek, Wiarton (CA); Darin Carlson, Cypress, TX (US)

(21) Appl. No.: 13/703,566

(22) PCT Filed: Jun. 17, 2011
(86) PCT No.: PCT/IB11/52667

§ 371 Date: Feb. 27, 2013

Related U.S. Application Data
(60) Provisional application No. 61/355,688, filed on Jun. 17, 2010.

(51) Int. Cl. F16K 31/54; F16H 19/04

(52) U.S. Cl. CPC F16K 31/54; F16H 19/04
USPC 251/250; 74/30

(57) ABSTRACT

An actuator for a valve assembly is provided. The actuator has an actuator body and at least one piston configured to travel within the actuator body. The actuator has an output shaft located at least partially within the actuator body and configured to couple to a valve stem of a valve wherein the output shaft has a plurality of teeth protruding from a pinion. The actuator has at least one rack configured to move with each of the at least one piston, the rack having a piston end and a terminal end and wherein the rack has a plurality of rack teeth configured to engage the plurality of teeth on the output shaft. The terminal end of the rack is configured to be maintained a minimum distance beyond an engagement point, wherein the engagement point is located between the rack teeth and the teeth in all operating positions.

### CROSS-REFERENCE TO RELATED APPLICATIONS

This application claims the benefit of U.S. Provisional Application No. 61/355,688 filed Jun. 17, 2010.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

A valve in piping systems may have any number of actuators. The actuators may be manual actuators, pneumatic actuators, hydraulic actuators, electric actuators, a combination thereof and the like. The actuators may move the valve between an open position and a closed position. The actuators may have a position indicator to indicate the position of the valve. Many automatic valves are configured to operate between the open and closed position at a high rate. For example, the valve may operate several times per minute. The high frequency of use creates high wear and tear on the components of the actuator. Therefore, there is a need for an actuator having a robust actuation system.

### SUMMARY

Embodiments described herein provide an actuator for a valve assembly. The actuator has an actuator body and at least one piston configured to travel within the actuator body. The actuator has an output shaft located at least partially within the actuator body and configured to couple to a valve stem of a valve wherein the output shaft has a plurality of teeth protruding from a pinion. The actuator has at least one rack coupled to and configured to move with each of the at least one piston, the rack having a piston end and a terminal end and wherein the rack has a plurality of rack teeth configured to engage the plurality of teeth on the output shaft. The terminal end of the rack is configured to be maintained a minimum distance beyond an engagement point, wherein the engagement point is located between the rack teeth and the teeth in all operating positions.

### BRIEF DESCRIPTION OF THE DRAWINGS

FIG. 1 is a schematic view of a piping system having a valve assembly.

FIG. 2 is a cross-sectional top view of an actuator of the piping system of FIG. 1.

FIG. 3 is a perspective cut-away view of one embodiment of an actuator.

FIG. 4 is a perspective view of an embodiment of a piston and rack.

FIG. 5 is a flow chart of a method for using the actuator of FIG. 1.

### DETAILED DESCRIPTION OF PREFERRED EMBODIMENT(S)

The description that follows includes exemplary apparatus, methods, techniques, and instruction sequences that embody techniques of the inventive subject matter. However, it is understood that the described embodiments may be practiced without these specific details.

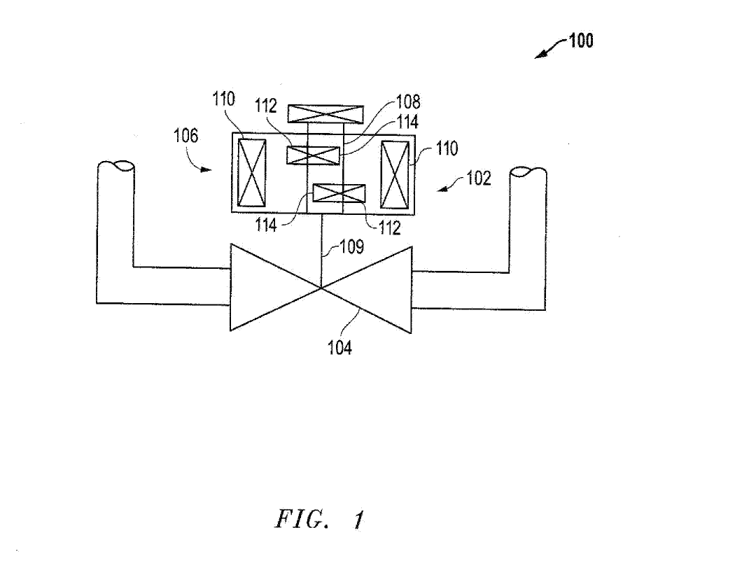

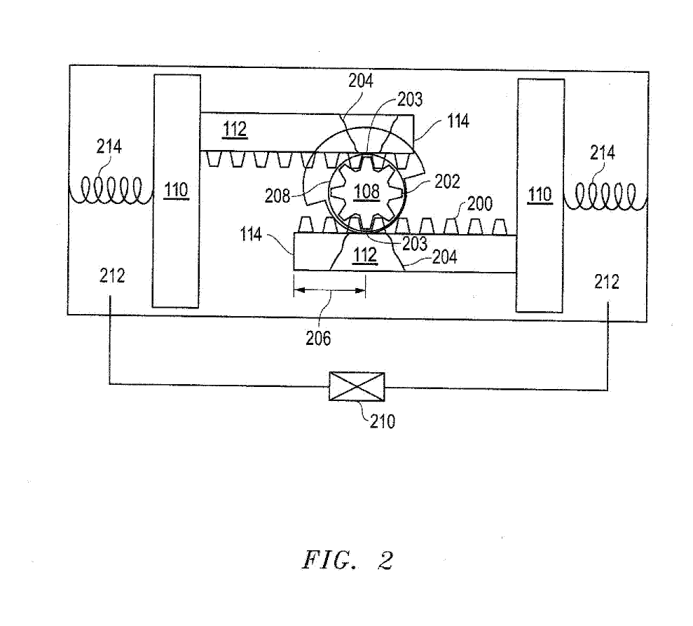

FIG. 1 depicts a schematic view of a piping system 100 having a valve assembly 102. The valve assembly 102 may be for controlling flow in the piping system 100. The valve assembly 102 may have a valve 104 and an actuator 106. The valve 104 is configured to control flow in the piping of the piping system 100. The valve 104 may be any suitable valve including, but not limited to a butterfly valve, a ball valve, a plug valve, a control valve, and the like. The actuator 106 may be configured to automatically actuate the valve 104 between an open and closed position. The actuator 106 may have an output shaft 108 for moving the valve between the open and closed position. The output shaft 108 may couple to or be mechanically linked with a valve stem 109. The output shaft 108 may be moved from between the open and closed position by one or more pistons 110 coupled to or integral with one or more racks 112. The rack 112 may have a plurality of rack teeth 200 that engage teeth 202 (as shown in FIG. 2) on the output shaft 108 as will be described in more detail below. The rack 112 may have additional number of teeth that do not engage the output shaft during the operation of the valve 104. The additional teeth will be between a terminal end 114 of the rack 112 and an engagement point 203 (as shown in FIG. 2). Therefore, at least one, two, three or more of the teeth never engages the teeth on the output shaft 108. The actuator 106 may be configured to maintain a minimum distance or length 206 between the terminal end 114 of the rack 112 and the engagement point 203 during the life of the actuator 106. The actuator 106 may have a position indicator 116 to determine the position of the closure member of the valve 104.

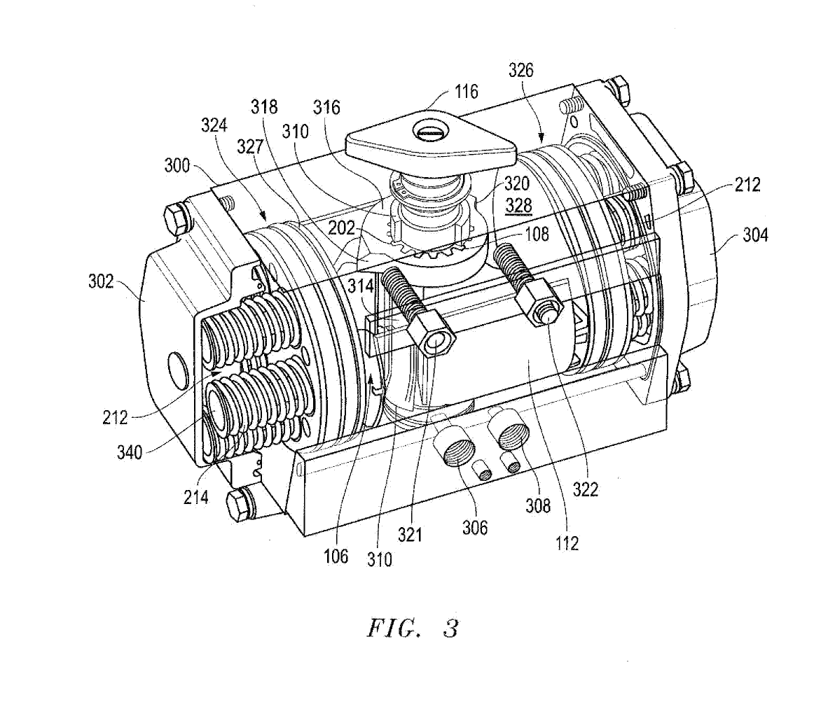

FIG. 2 depicts a cross-sectional top view of the actuator of FIG. 1. The plurality of rack teeth 200 is shown engaging a plurality of teeth 202 on a pinion gear 314 (see FIG. 3) integral to or mounted on the output shaft 108. The rack 112 may be designed to have the terminal end 114 of the rack 112 always remain a minimum distance 206 relative to a specific number of rack teeth 200. The minimum distance may be at least the distance assessed parallel to the rack 112 of one of the rack teeth 200. In another embodiment, the minimum distance 206 may be at least the distance assessed parallel to the rack 112 of two of the rack teeth 200. In yet another embodiment, the minimum distance may be at least the distance assessed parallel to the rack 112 of three of the rack teeth 200. The engagement point 203 may be the interface between the rack teeth 200 and the teeth 202 at an engagement zone 204. High stresses occur in the rack 112 at the engagement zone 204. The engagement zone 204 is the area proximate where the rack teeth 200 engage the teeth 202 on the pinion gear 314. By preventing the terminal end 114 from reaching the engagement zone 204, the stresses in the rack teeth 200 may remain evenly distributed over the rack teeth 200 and/or the rack 112. In one embodiment, the length 206, between the terminal end 114 and the engagement zone 204 may be between 2%-12% of an outer circumference 208 of the output shaft 108. In another embodiment, the terminal end 114 always remains a minimum distance of at least one or two rack teeth 200 away from the engagement point 203.

A controller 210 may be used to feed fluid into one or more piston chambers 212 in order to move the output shaft 108 between the open and closed position. As described herein, the fluid is a pneumatic fluid, although it may be any suitable fluid such as a hydraulic fluid. The pistons 110 may be biased toward the output shaft 108 by one or more biasing member(s) 214. The biasing member(s) 214 are optional. Although the biasing members 214 are shown as biasing the pistons 110 toward the output shaft 108, it should be appreciated that the biasing members 214 may bias the pistons 110 away from the output shaft 108, or may bias one piston 110 away and the other piston 110 toward the output shaft 108. The biasing members 214 may be any suitable biasing member including, but not limited to, coiled springs, leaf springs, and the like.

FIG. 3 depicts a perspective cut-away view of one embodiment of the actuator 106. The actuator 106 may have an actuator body 300 and two end caps 302 and 304 configured to house the pistons 110, the racks 112, the biasing members 214, and the output shaft 108. The actuator body 300 may define the piston chambers 212, or pneumatic chambers. The actuator body 300 may have ports 306 and 308 for supplying the fluids to the piston chambers 212. The ports 306 and 308 as shown are integral with the actuator body 300 thereby reducing the cost of external tubing and the risk of the ports becoming damaged during operation. The two end caps 302 and 304 as shown are bolted to the actuator body 300 in order to seal the piston chambers 212 although, they may be attached with any suitable method including but not limited to welding.

The actuator body 300 and/or the piston chambers 212 may be extended in length to accommodate the longer rack 112 and more rack teeth 200. The extended length may correspond to the extra length of the rack 112. Further, the extended length may be greater than, or slightly less than the extended length of the rack 112.

The output shaft 108 may extend through the actuator body 300 for connection with the valve stem and the position indicator 116. The output shaft 108 may have one or more bearings 310 configured to support the output shaft 108 in the actuator body 300. A center axis of the output shaft 108 may be mounted substantially perpendicular to the center axis of the piston chambers 212. The output shaft 108 may couple to, or have an integral, pinion gear 314. The pinion gear 314 may include the teeth 202 for engaging the rack teeth 200. Therefore, as the pistons 110 move the rack 112 and the rack teeth 200 the pinion gear 314 is rotated thereby rotating the valve stem 109 and/or the position indicator 116.

The output shaft 108 may couple to or have an integral travel stop cam 316. As shown the integral stop cam 316 has two shoulders 318 and 320 each configured to engage a travel stop 321 and 322 respectively. The travel stops 321 and 322 as shown are screws that pierce the actuator body 300. The length of the screws may be adjusted from outside the actuator body 300 thereby allowing the operator to adjust the rotational travel of the output shaft 108. When the shoulders 318 and 320 engage the travel stops 321 and 322, the output shaft 108 will stop rotating and thereby increase the force between the rack teeth 200 and the teeth 202. When the travel stops 321 and/or 322 are reached, the travel stop cam 316 ceases rotation of the output shaft 108, which causes the output shaft to suddenly cease rotation. This sudden stop places additional stress on the last engaged tooth on the piston rack 112. Problems are statistically more likely to occur in rapid speed, high frequency (high cycle) operations as compared to normal speed, normal frequency (standard cycle) operations. An example of a “high cycle” operation includes applications in which the piston is repeatedly cycled once every minute, every day, of every year. Under these conditions tremendous cumulative stress may be placed upon the last rack teeth 200 on the racks 112 over the cycles relative to time. Because the engagement zone 204 is spaced away from the terminal end 114 of the rack 112, the increased force will be distributed as a stress over a larger area of the rack 112 thereby reducing the stress concentration in the rack 112 and in the rack teeth 200.

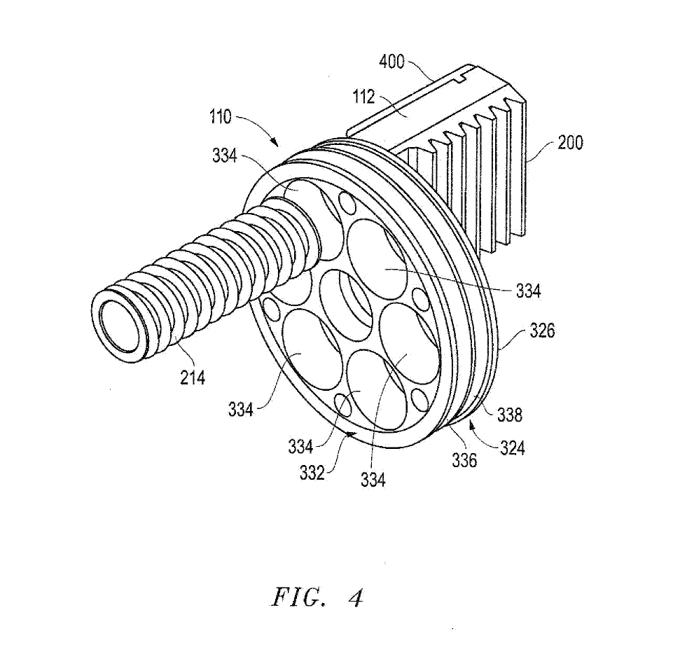

FIG. 4 depicts a perspective view of an embodiment of the piston 110 and the rack 112. As shown in the embodiment(s) of FIGS. 1-3 there are two pistons 110 and two eccentrically mounted racks 112 although it should be appreciated that there may be only one piston 110 and/or one rack 112. The two racks 112 may be parallel to one another thereby allowing the rack teeth 200 for each of the two racks 112 to engage the teeth 202 of the output shaft 108 on opposite sides of the output shaft. Having the two racks 112 may allow the pistons 110 to quickly and efficiently actuate the output shaft 108 and thereby the valve 104 in both directions between the open and closed position.

The pistons 110 as shown are integral with the racks 112, although the racks 112 may be a separate piece that is coupled to the pistons 110. The pistons 110 may respectively have a piston head 324 and 326. A top 327 and 328 of the respective piston heads 324 and 326 may be configured for supporting the rack 112. A bottom 330 and 332 of the respective piston heads 324 and 326 may be configured to receive the one or more biasing members 214. The bottom 330 and/or 332 may have one or more cavities 334 for receiving the one or more biasing members 214. The cavities 334 (or seats), as shown, may be configured to maintain the biasing members 214 within the cavity 334 on the piston 110. Thus, the cavities 334 may prevent the biasing members 214 from shifting or moving during the operation of the actuator 106.

A piston guide 336 may be secured around the circumference of the piston 110. The piston guide 336 may be a material, or combination of materials, having a low coefficient of friction and able to absorb side thrust from the inner wall of the actuator body 300. A piston seal 338 may be used to seal the piston chamber 212 (as shown in FIG. 2) during the life of the actuator 106. The piston seal 338 may be an elastomeric O-ring or any other suitable seal.

The one or more biasing members 214 as shown in FIG. 3 are six spring cartridges 340 placed in the cavities 334 of the piston 110. The spring cartridges 340 may be mounted between the piston 110 and the end caps 302 and 304. Both the pistons 110 and the end caps 302 and 304 may have the cavities 334 (or seats) for securing the spring cartridges 340 in place. Although six spring cartridges 340 are shown it should be appreciated that any number of spring cartridges may be used, if any. The number of spring cartridges 340, and/or the type of biasing member 214, may be varied based on the available fluid pressure of the fluid supply.

The racks 112 as shown in FIG. 4 may have a rack guide 400. The rack guide 400 may secure to the portion of the rack 112 facing the inner wall of the actuator body 300 (as shown in FIG. 3). The rack guide 400 may be constructed of a high strength and low friction material. The rack guide 400 is configured to support the travel path of the rack 112 and/or the piston 110.

The position indicator 116 as shown is an output shaft 108 position indicator. The position indicator 116 may clearly show an operator the location of the output shaft 108 and whether the valve 104 is in the open or closed position. The position indicator 116 may be any suitable position indicator.

The advantage(s) include that the service life of the actuator is increased whether operating at normal opening/closing frequencies (normal opening/closing frequencies indicated in brochures available from Bray International, Inc.) or at slower or faster frequencies. Two or more additional teeth 200 are added to the terminal end 114 of the series of teeth on the piston rack(s) 122. The failure rate of a last tooth or the last few teeth is decreased because the load is distributed over two or more teeth 200 even at the full extent of travel when the actuator is operated at high cycle rates. The resulting pneumatic actuator requires fewer repairs and/or replacements thereby increasing the service life and reliability of the pneumatic actuator. In that sense, this was discovered to be a critical improvement in certain applications.

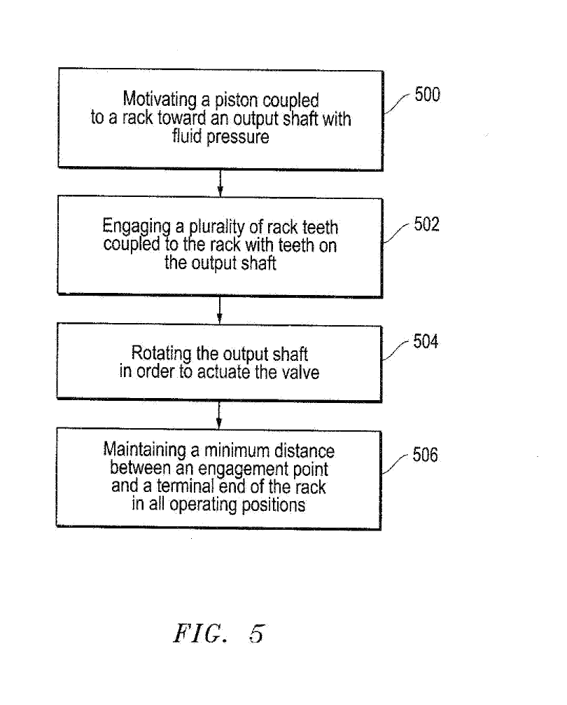

FIG. 5 depicts a flow chart of a method for using the actuator of FIG. 1. The flow chart begins at block 500 wherein the piston 110 coupled to the rack 112 is motivated toward (or away from) the output shaft 108 with fluid pressure and/or evacuation. The flow continues at block 502 wherein the plurality of rack teeth 200 coupled to the rack 112 engage teeth 202 on the output shaft 108. The flow continues at block 504 wherein the output shaft 108 is rotated in order to actuate the valve 104 between and including the open position and the closed position. The flow continues at block 506 wherein a minimum distance is maintained between an engagement point and a terminal end of the rack in all operating positions of the valve 104.

While the embodiments are described with reference to various implementations and exploitations, it will be understood that these embodiments are illustrative and that the scope of the inventive subject matter is not limited to them. Many variations, modifications, additions and improvements are possible. For example, the implementations and techniques used herein may be applied to any actuator for piping systems, such as in hydraulic actuators and the like.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An actuator for a valve assembly, comprising:
an actuator body;
at least one piston configured to travel within the actuator body;
an output shaft located at least partially within the actuator body and configured to couple to a valve stem of a valve wherein the output shaft has a plurality of teeth protruding from a pinion;
at least one rack coupled to and configured to move with each of the at least one piston the rack having a piston end and a terminal end and wherein the rack has a plurality of rack teeth configured to engage the plurality of teeth on the output shaft; and
wherein the terminal end of the rack is configured to be maintained a minimum distance beyond an engagement point, wherein the engagement point is located between the rack teeth and the teeth in all operating positions.

2. The actuator of claim 1, wherein the at least one rack has at least one of the rack teeth between the terminal end and the engagement point at all times.

3. The actuator of claim 1, wherein the at least one rack has at least two of the rack teeth between the terminal end and the engagement point at all times.

4. The actuator of claim 1, wherein the at least one rack has at least three of the rack teeth between the terminal end and the engagement point at all times.

5. The actuator of claim 1, further comprising a rack guide for guiding the at least one rack and the piston.

6. The actuator of claim 1, further comprising at least one biasing members configured to bias each of the at least one piston.

7. The actuator of claim 1, wherein the at least one rack further comprise two racks parallel to one another and wherein the rack teeth for each of the two racks engage the teeth of the output shaft on opposite sides of the output shaft.

8. A system for controlling flow in a piping system, comprising:
a valve;
a valve stem;
an actuator comprising:
an actuator body;
at least one piston configured to travel within the actuator body;
an output shaft located at least partially within the actuator body and configured to couple to the valve stem of the valve wherein the output shaft has a plurality of teeth protruding from a pinion;
at least one rack coupled to and configured to move with each of the at least one piston, the rack having a piston end and a terminal end and wherein the rack has a plurality of rack teeth configured to engage the plurality of teeth on the output shaft; and
wherein the terminal end of the rack is configured to be maintained a minimum distance beyond an engagement point, wherein the engagement point is located between the rack teeth and the teeth in all operating positions.

9. The system of claim 8, wherein the at least one rack has at least one of the rack teeth between the terminal end and the engagement point at all times.

10. The system of claim 8, wherein the at least one rack has at least two of the rack teeth between the terminal end and the engagement point at all times.

11. The system of claim 8, wherein the at least one rack has at least three of the rack teeth between the terminal end and the engagement point at all times.

12. The system of claim 8, wherein the at least one rack further comprises two racks parallel to one another and wherein the rack teeth for each of the two racks engage the teeth of the output shaft on opposite sides of the output shaft.

13. The system of claim 12, wherein the valve is a high cycle valve configured to operate between the open and closed position at least once every hour.

14. The method for actuating a valve, comprising:
motivating a piston coupled to a rack toward an output shaft with fluid pressure;
engaging a plurality of rack teeth coupled to the rack with teeth on the output shaft;
rotating the output shaft in order to actuate the valve; and
maintaining a minimum distance between an engagement point and a terminal end of the rack in all operating positions.

15. The method of claim 14, wherein maintaining the minimum distance comprises having at least one of the rack teeth positioned between the terminal end and the engagement point at all times.

16. The method of claim 14, wherein maintaining the minimum distance comprises having at least two of the rack teeth positioned between the terminal end and the engagement point at all times.

17. The method of claim 14, wherein maintaining the minimum distance comprises having at least three of the rack teeth positioned between the terminal end and the engagement point at all times.

18. The method of claim 14, further comprising biasing the piston toward the output shaft.

19. The method of claim 14, further comprising actuating the valve between an open and closed position at least once per hour.

20. The method of claim 14, further comprising actuating the valve between an open and closed position at least once per minute.
